(19) United States
(12) Patent Application Publication
(10) Pub. No.: US 2017/0000094 A1
(43) Pub. Date: Jan. 5, 2017

(54) SEGMENTED FISH PUMP SYSTEM

(71) Applicant: Merton L. BARTSCH, White Bear Lake, MN (US)

(72) Inventor: Merton L. BARTSCH, White Bear Lake, MN (US)

(21) Appl. No.: 14/788,733

(22) Filed: Jun. 30, 2015

(51) Int. Cl. A01K 79/00; F04F 5/42; F04F 5/24

(52) U.S. Cl. CPC A01K 79/00; F04F 5/24; F04F 5/42

(57) ABSTRACT

A segmented fish pump system is provided. The segmented fish pump system includes a series of booster pump segments stacked upon an intake pump segment, forming an enclosed stream throughout, wherein each booster pump segment induces further upward flow, thereby minimizing the pressure and velocity needed for the intake pump of the intake pump segment. As a result, lessening trauma to fragile aquatic life at collection and further providing a nautical environment within the enclosed stream for the aquatic life to be transported as well as self-propelled to higher elevations.

### BACKGROUND OF THE INVENTION

The present invention relates to the fishing industry and, more particularly, to a segmented fish pump system that includes a series of booster pump segments stacked upon an intake pump segment, forming an enclosed stream, wherein each booster pump segment induces further upward flow, thereby minimizing the pressure and velocity needed for the intake pump of the primary intake pump segment.

In the past, fish moving systems were either fish pumps designed to unload fish from ship holds up a limited height to processing stations, or are relatively crude mechanical devices that trap fish in baskets and are mechanically elevated up and over dams. The fish unloading devices worked well for their intended purpose of a limited range; however, their energy input is high, and the action is violent and harmful to spawning fish. And the mechanical devices are pretty clumsy and impractical devices.

More recently, “Coanda” effect pumping systems have been used to move a liquid containing fish to elevated heights. Still, the common limitation of all Coanda effect pumps is the risk of trauma to the fish caused by high water pressures and velocities required to lift the liquid containing fish out of the ships hold or a lower body of water. In particular, using a Coanda effect pump to transport live fish is most problematic at the intake portion of these fish pumping systems for the following reasons. First, the turbulence caused by the mixing of high velocity, high pressure jets with the incoming low velocity suction flow induced by the Coanda effect can generally cause physical damage to the fish. Moreover, the natural tendency of a fish is to move against a current so the fish typically enter such Coanda effect pumping systems swimming into the suction flow, thereby entering the intake portion tail first, making higher velocities of intake flow more traumatic and damaging to the collected fish.

The most recent Coanda effect pumping systems have resorted to a complicated and expensive arrangement of chambers, collection bins, and other components in order to ensure that the velocity of the intake flow is slow enough to prevent trauma to the fish, other aquatic life and/or product during the collection.

As can be seen, there is a need for a segmented fish pump system that includes a series of booster pump segments stacked upon an intake pump segment, forming an enclosed stream, wherein each booster pump segment induces further upward flow, thereby minimizing the pressure and velocity needed for the intake pump of the intake pump segment at the initial collection.

### SUMMARY OF THE INVENTION

In one aspect of the present invention, segmented pump system for transporting liquid by induced flow throughout a series of system segments includes an intake segment having a lower intake portion and an upper intake portion, wherein the intake segment comprises an intake bell fluidly connected to an intake pump, wherein the intake pump is configured to provide pressured jet flow near the upper portion so as to induce a collection flow near the lower intake portion; an inlet pipe extending from a lower mouth to an upper portion, wherein the lower mouth vertically connects the inlet pipe to the upper intake portion of the intake segment; at least one booster pipe segment extending from a lower booster mouth to an upper booster portion, wherein the lower booster mouth vertically connects the booster pipe segment to the upper portion of the inlet pipe or the upper portion of an adjacent booster pipe segment; a transitory booster region circumferentially disposed near the lower booster mouth of each booster pipe segment, wherein each transitory booster region forms a booster inlet and a vertically adjacent booster outlet, each fluidly communicating an internal portion of its booster pipe segment to an external portion thereof; and at least one booster pump mounted along the external portion of each booster pipe segment so each booster pump fluidly interconnects the booster inlet and outlet thereof.

These and other features, aspects and advantages of the present invention will become better understood with reference to the following drawings, description and claims.

### BRIEF DESCRIPTION OF THE DRAWINGS

FIG. 1 is side view of an exemplary embodiment of the present invention, shown in use; and

FIG. 2 is a detailed section view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a segmented fish pump system that includes a series of booster pump segments stacked upon an intake pump segment, forming an enclosed stream throughout, wherein each booster pump segment induces further upward flow, thereby minimizing the pressure and velocity needed for the intake pump of the intake pump segment. As a result, lessening trauma to fragile aquatic life at collection and further providing a nautical environment within the enclosed stream for the aquatic life to be transported as well as self-propelled to higher elevations.

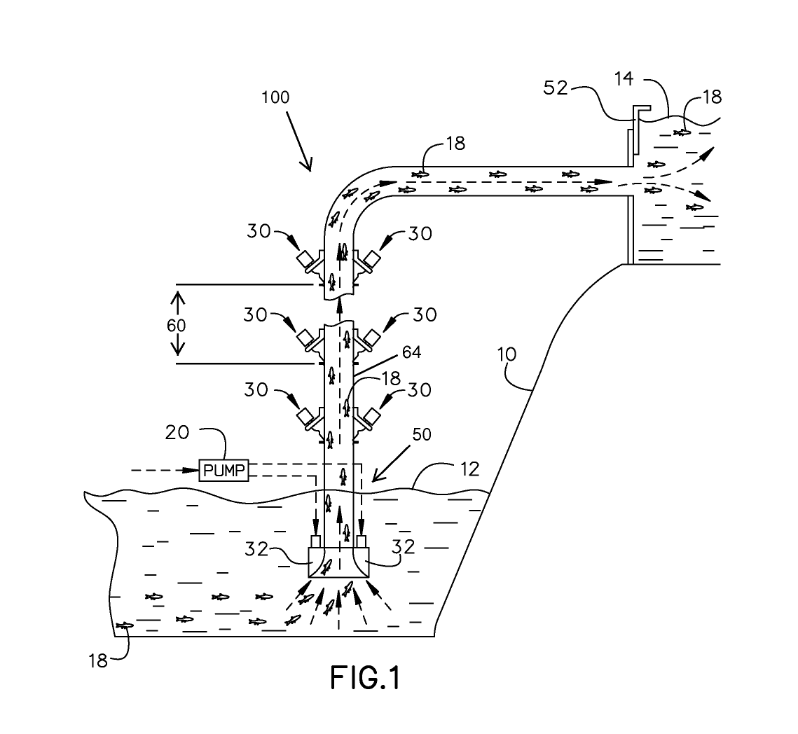

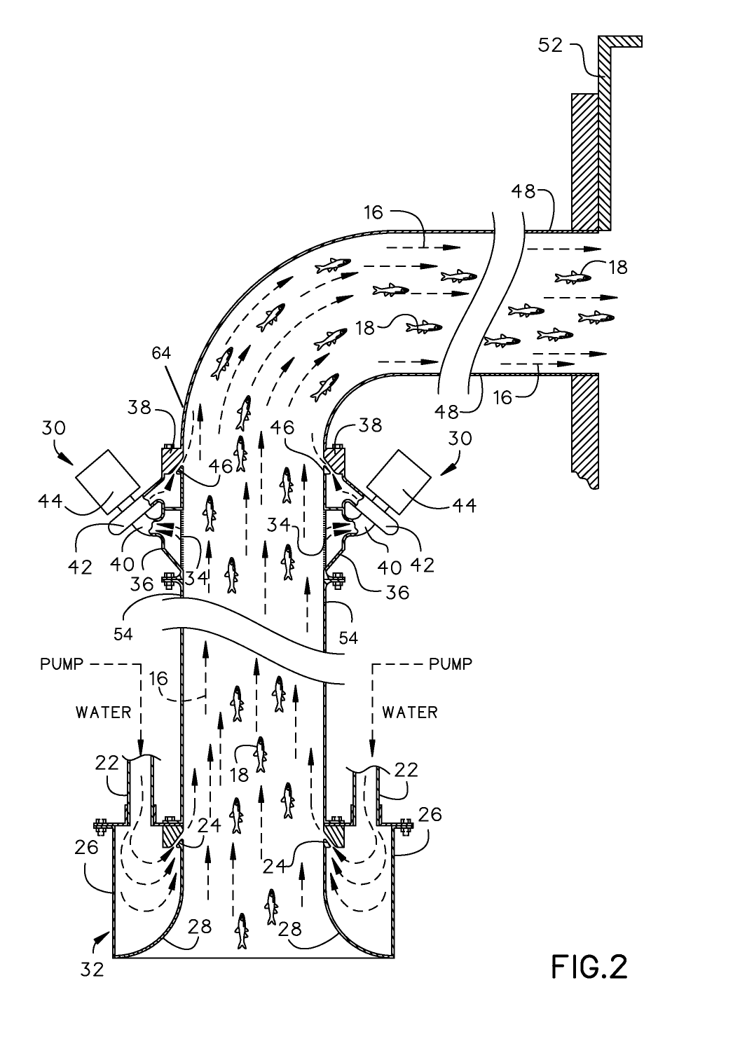

Referring to FIGS. 1 and 2, the present invention may include a segmented fish pumping system 100 embodying a method of elevating a liquid 16 contain fragile aquatic life 18 from a lower liquid body 12 to an upper liquid body 14. For example, the system 100 would allow migrating fish to swim and/or be transported over a dam 10 in a river. The segmented fish pumping system 100 provides a series of booster pump segments 60 vertically stacked on an intake segment 50, thereby lessening the demand on the intake pumps 20 of the intake segment 50. The segmented fish pumping system 100 also facilitates the formation of an enclosed stream, replicating a nautical environment during such elevated transport, as illustrated in FIG. 1.

It should be noted that the use of the terms “lower,” “downward,” “upper,” “upward,” “vertical” and the like herein may be defined in analogy to the elevation being traversed by the present invention. The intake segment 50 may be partially submerged in the lower liquid body 12 as the necessary first step in the present invention. The intake segment 50 may include an inlet pipe 54 connected to an intake bell 26 submerged within the lower liquid body 12. The intake bell 26 may form an intake nozzle 28 that extends from a mouth tapering to an upper portion. The mouth of the intake nozzle 28 is approximately twice the diameter of the inlet pipe 54 that it is in fluid communication with the upper portion of the intake nozzle 28. Along a periphery of the intake nozzle 28, the intake bell 26 may form a plenum chamber 32. The intake nozzle 28 may form an intake jet orifice 24 along its circumference so that the upper portion of the intake nozzle 28 and an upper portion of the plenum chamber 32 are in fluid communication near a lower mouth of the inlet pipe 54

The plenum chamber 32 may be in fluid communication through pump pipes 22 to intake pumps 20. The intake pumps 20 may be the source of energy for moving large volumes of liquid at a steady flow so as to pressurize the liquid in the plenum chamber 32. The intake pumps 20 may be any suitable inductor pumps so long as the intake pumps 20 function in accordance with the present invention as described herein.

The intake jet orifice 24 may be dimensioned and adapted to produce an evenly distributed, high pressure, upwardly-directed intake jet flow (of liquid contained within the plenum chamber 32) near the mouth of the inlet pipe 54, as illustrated in FIG. 2. The high pressure intake jet flow near the upper portion of the intake nozzle 28 induces a Coanda reactionary liquid flow from the lower liquid body 12 created by the low pressure area existing near the mouth of the intake nozzle 28. This induced Coanda flow velocity is slow enough to prevent trauma to the aquatic life 18 during the collection. The induced Coanda flow and the intake jet flow form a main flow through the inlet pipe 54.

The intake pumps 20 may provide suitable pressures and velocities to lift the aquatic life to the needed transfer of the initial booster segment 60 dimensioned and adapted to maintain the continuation of movement via booster pumps 30. The intake segment 50 transfers to the initial booster segment 60 where the inlet pipe 54 smoothly connects to the booster pipe 64 so as to maintain the enclosed stream at a substantially identical diameter with no protrusions projecting into the enclosed stream. Each booster pipes 64 extends from its lower mouth to an upper portion thereof and along the way may include bends as well as straight portions.

Booster pumps 30 are dimensioned and adapted to piggy back onto the exterior of the booster pipe 64 so as not to encroach on the nautical environment of the enclosed stream therein. Each booster pump 30 may include an inlet manifold 36 and an outlet manifold 38 that extend over a transitory booster region near the mouth of the booster pipe 64. A lower portion of the transitory booster region may form a booster inlet along a circumference of the booster pipe 64. The booster pump 30 may be a centrifugal pump 32 powered by a motor 44. An upper portion of the transitory booster region may form a booster outlet. The booster jet orifice 46 may be dimensioned and adapted to produce an evenly distributed, high pressure upwardly-directed booster jet flow through the booster outlet.

The transitory booster region is peripheral and its booster inlet may be protected by the inlet screen 34. Therefore, the intake velocities at the booster pipe 64 wall defined by the transitory booster region are low and present no hazard to passing fish. As with the intake segment 50 and the piping system as a whole, there are no mechanical projections of any kind into the enclosed stream to harm fish. The number of booster pumps 30 and booster segments 60 needed are dependant entirely on the desired lift height/elevation, and the design criteria of the system.

Each booster pump 30 withdraw liquid from the main flow through its booster inlet and re-energize the flow by adding pressure to the flow stream through the booster outlet. As the liquid moves up the inlet pipe 54 and then the booster pipes 64 it gains potential energy by its increased elevation and loses kinetic energy by losing velocity. By utilizing a multitude of low cost booster pumps 30, pressures and velocities can be maintained at a modest level. The addition of compressed air at the intake pumps 20 provides a lower density column of water which will tend to rise on its own accord. The compressed air in the water will tend to separate, but when drawn through the booster pumps 30 will be re-diffused in the liquid. The liquid in the upwardly-vertical booster pipes 64 may be a tranquil enough enclosed stream that the aquatic life 18 may be inclined to use their own energy and swim upwards. This action may be enhanced by the installation of lights near the upper portion of the booster pipes 64. It may be important that the booster pipes 64 be maintained vertical otherwise entrained air will tend to separate on the high side of the booster pipe 64 and “shortcut” it's way to the exit thereby depriving the system of its lift.

The booster pumps 30 use the same Coanda principle to induce flow as the intake pump 20 does at the intake segment 50. However, the booster pumps 30 are unique in that high pressure liquid is not added to the flow since the addition of more and more liquid to the transporting pipe would either create higher and higher pressures and velocities, or would simply stop flow. To avoid this scenario, a percentage of the main flow is withdrawn, re-energized via the externally mounted booster pumps 30, and reintroduced to the main flow in the form of high pressure liquid jets as the liquid flows across each transitory booster region. The removal of the liquid from the main flow reduces the pressure in the immediate area and thereby enhances flow to that area. The reintroduction of the liquid in the form of high pressure jets in the immediate area creates additional low pressure behind the booster jet orifices 46 to further enhance the flow. The peripherally formed high pressure jets orifices 46 blend with the main flow to restore its kinetic energy and velocity.

Each booster segment 60/pipe 64 may be connected to an adjacent booster segment 60/pipe 64, the intake segment 50/pipe 54, or the discharge pipe 48 by any suitable means that maintain the enclosed stream without substantially projecting components therein. In certain embodiments, the connection between said segments/pipes is at least partially formed by use of the inlet manifold 36. In certain embodiments, said segments/pipes may provide externally protruding flanges for making such connections.

A gate 52 may be provided at an upper terminus of the discharge pipe 48 so that the system 100 can be shut down when the spawning season is over, whereby the gate may be operable connected to the upper portion of the discharge pipe segment so that the gate is movable in an open configuration and a closed configuration, wherein the closed configuration prevents liquid flowing to and from the discharge pipe segment from and to the upper liquid body 14. The present invention can also be used as a safe path out in the spring for the fingerlings by reducing the speed of the enclosed stream to minimum or “no-flow”. The fingerlings can swim down the enclosed stream and out to sea safely bypassing any power turbines or steep spillways associated with the dam 10. By introducing the fingerlings to this path, it may be embedded in their mind for years later when they return to spawn.

It should be understood, of course, that the foregoing relates to exemplary embodiments of the invention and that modifications may be made without departing from the spirit and scope of the invention as set forth in the following claims.

What is claimed is:

1. A segmented pump system for transporting liquid by induced flow throughout a series of system segments, comprising:
an intake segment having a lower intake portion and an upper intake portion, wherein the intake segment comprises an intake bell fluidly connected to an intake pump, wherein the intake pump is configured to provide pressured jet flow near the upper portion so as to induce a collection flow near the lower intake portion;
an inlet pipe extending from a lower mouth to an upper portion, wherein the lower mouth vertically connects the inlet pipe to the upper intake portion of the intake segment;
at least one booster pipe segment extending from a lower booster mouth to an upper booster portion, wherein the lower booster mouth vertically connects the booster pipe segment to the upper portion of the inlet pipe or the upper portion of an adjacent booster pipe segment;
a transitory booster region circumferentially disposed near the lower booster mouth of each booster pipe segment, wherein each transitory booster region forms a booster inlet and a vertically adjacent booster outlet, each fluidly communicating an internal portion of its booster pipe segment to an external portion thereof; and
at least one booster pump mounted along the external portion of each booster pipe segment so each booster pump fluidly interconnects the booster inlet and outlet thereof.

2. The segmented pump system of claim 1, further comprising at least one discharge pipe segment extending from a lower discharge mouth to an upper discharge portion, wherein the lower discharge mouth vertically connects the discharge pipe segment to the upper portion of an adjacent booster pipe segment.

3. The segmented pump system of claim 2, further comprising a gate operable connected to the upper portion of the discharge pipe segment so that the gate is movable in an open configuration and a closed configuration.

4. The segmented pump system of claim 1, wherein the intake bell extends from the lower intake portion toward and an upper intake bell portion fluidly communicating to the lower mouth of the inlet pipe, and wherein the intake bell at the lower intake portion has a diameter approximately twice that of said lower mouth of the inlet pipe.

5. The segmented pump system of claim 4, further comprising a plenum chamber formed along an external periphery of the intake bell so as to fluidly interconnect the intake bell and the intake pump, and wherein the intake bell forms an intake jet orifice along a periphery of the upper intake bell so as to fluidly communicate with the plenum chamber.

6. The segmented pump system of claim 5, wherein the intake jet orifice is configured to produce an upwardly-directed intake jet flow along an internal periphery of the intake bell.

7. The segmented pump system of claim 1, further comprising an inlet screen disposed along each booster inlet.

8. The segmented pump system of claim 7, further comprising a booster jet orifice disposed along each booster outlet, wherein each booster jet orifice is configured to produce an upwardly-directed booster jet flow along an internal periphery of the booster pipe segment.

9. The segmented pump system of claim 1, further comprising a manifold interconnecting each externally mounted booster pump, wherein the manifold in at least part connects the lower booster mouth to the upper portion of the inlet pipe or the upper portion of the adjacent booster pipe segment.
